(19) United States
(12) Patent Application Publication
(10) Pub. No.: US 2026/0351765 A1
(43) Pub. Date: Nov. 5, 2026

(54) BATTERY PACK FOR AN ELECTRIC VEHICLE

(71) Applicant: BOMBARDIER RECREATIONAL PRODUCTS INC., Valcourt (CA)

(72) Inventors: Jean-Francois LAMBERT, Orford (CA); Jonathan FORTIER, Lawrenceville (CA)

(21) Appl. No.: 19/124,496

(22) PCT Filed: Oct. 19, 2023
(86) PCT No.: PCT/IB2023/060579

§ 371 Date: Apr. 25, 2025

Related U.S. Application Data
(60) Provisional application No. 63/420,937, filed on Oct. 31, 2022.

(51) Int. Cl. H01M 50/249; B62M 27/02; H01M 50/204; H01M 50/291

(52) U.S. Cl. CPC H01M 50/249; B62M 27/02; H01M 50/204; H01M 50/291

(57) ABSTRACT

A battery pack and an electric vehicle including the battery pack. The vehicle includes a frame; a straddle seat supported by the frame; at least one ground-engaging member operatively connected to the frame; an electric motor being operatively connected to the at least one ground-engaging member for driving the at least one ground-engaging member; an electric powerpack operatively connected to the electric motor including the battery pack. The battery pack includes a battery housing; and a plurality of battery cells disposed in the battery housing, the battery housing defining therein: a first aperture, and a second aperture, a passage through the battery pack extending from the first aperture to the second aperture, the at least one passage being arranged to receive at least one solid vehicle component extending through the battery pack.

### CROSS-REFERENCE

The present application claims priority to U.S. Provisional Application No. 63/420,937, entitled “Battery Pack for an Electric Vehicle,” filed Oct. 31, 2023, the entirety of which is incorporated by reference herein.

### FIELD OF TECHNOLOGY

The present technology relates to battery packs for electric vehicles.

### BACKGROUND

As the move toward electrification of vehicles progresses, interest in electric versions of different vehicles, including recreational vehicles such as snowmobiles and all-terrain vehicles (ATVs), with improved range and performance continues. In some cases, improving range and performance is solved by inclusion of a relatively large battery assembly, such as a large traction battery.

When incorporating a large traction battery into a vehicle, however, difficulty could be encountered in fitting the battery into the frame and/or around other necessary vehicle components. This can especially be an issue for smaller recreational vehicles, where some components such as steering columns and drive shafts occupy relatively large areas within the vehicle body.

There is therefore a desire for battery pack arrangements for electric vehicles addressing at least some of the above described disadvantages.

### SUMMARY

It is an object of the present technology to ameliorate at least some of the inconveniences present in the prior art.

According to one aspect of the present technology, there is provided a battery pack for an electric vehicle. The battery pack arrangement is structured to be integrated into the electric vehicle in an efficient manner, specifically by providing one or more passages through the battery housing, through which a non-battery component may extend.

According to one aspect of the present technology, there is provided a battery pack for an electric vehicle. The battery pack includes a battery housing; and a plurality of battery cells disposed in the battery housing, the battery housing defining therein: a first aperture, and a second aperture, a passage through the battery pack extending from the first aperture to the second aperture, the at least one passage being arranged to receive at least one solid vehicle component extending through the battery pack.

In some embodiments, the passage extends linearly between the first aperture and the second aperture.

In some embodiments, the first aperture is aligned with the second aperture, such that a line extending normal to a center of the first aperture extends normal to and through a center of the second aperture.

In some embodiments, the battery pack further includes a conduit extending at least partially from the first aperture to the second aperture, the passage being formed at least in part through the conduit.

In some embodiments, the passage is defined at least in part by a portion of the plurality of battery cells.

In some embodiments, the battery housing includes: a housing body, a first cover selectively connected to the housing body, a first chamber being defined between the housing body and the first cover, and a second cover selectively connected to the housing body on a side of the housing body opposite the first cover, a second chamber being defined between the housing body and the second cover; a first subgroup of battery cells of the plurality of battery cells is disposed in the first chamber; and a second subgroup of battery cells of the plurality of battery cells is disposed in the second chamber.

In some embodiments, the first aperture and the second aperture are both defined by one of the first cover and the second cover.

In some embodiments, the first aperture and the second aperture are defined at least in part by the housing body.

In some embodiments, the passage is a first passage; and a second passage is defined through the battery housing.

In some embodiments, the battery housing defines therein: a third aperture, and a fourth aperture; and the passage through the battery pack is defined at least in part by the first aperture, the second aperture, the third aperture, and the fourth aperture.

In some embodiments, the battery housing has a first dimension and a second dimension orthogonal to the first dimension; and the first dimension is greater than the second dimension.

In some embodiments, the passage extends generally parallel to the first dimension of the battery pack.

In some embodiments, the passage extends generally parallel to the second dimension of the battery pack.

In some embodiments, the first aperture, the second aperture, and the passage are sized and arranged for receiving a drive shaft of the electric vehicle through the battery pack, when the battery pack is installed in the electric vehicle.

In some embodiments, the first aperture, the second aperture, and the passage are sized and arranged for receiving a steering column of the electric vehicle through the battery pack, when the battery pack is installed in the electric vehicle.

In some embodiments, the first aperture, the second aperture, and the passage are sized and arranged for receiving a frame member of a frame of the electric vehicle through the battery pack, when the battery pack is installed in the electric vehicle.

In some embodiments, the at least one solid vehicle component is a rigid vehicle component; and the at least one passage is arranged to receive the rigid vehicle component through the battery pack.

In some embodiments, the rigid vehicle component is a rotating rigid vehicle component.

According to one aspect of the present technology, there is provided an electric vehicle including a frame; a straddle seat supported by the frame; at least one ground-engaging member operatively connected to the frame; an electric motor being operatively connected to the at least one ground-engaging member for driving the at least one ground-engaging member; an electric powerpack operatively connected to the electric motor, the powerpack including a battery pack. The battery pack includes a battery housing; and a plurality of battery cells disposed in the battery housing, the battery housing defining therein: a first aperture, and a second aperture, a passage through the battery pack extending from the first aperture to the second aperture, the at least one passage being arranged to receive at least one solid vehicle component extending through the battery pack.

In some embodiments, the electric vehicle further includes a steering column operatively connected to the at least one ground-engaging member, the steering column extending through the passage of the battery pack.

In some embodiments, the at least one ground engaging member includes two skis; and the vehicle is a snowmobile.

In some embodiments, the at least one solid vehicle component is a rigid vehicle component; and the at least one passage is arranged to receive the rigid vehicle component through the battery pack.

In some embodiments, the rigid vehicle component is a rotating rigid vehicle component.

For the purposes of the present application, terms related to spatial orientation such as forward, rearward, front, rear, upper, lower, left, and right, are as they would normally be understood by a driver of the vehicle sitting therein in a normal driving position with the vehicle being upright and steered in a straight ahead direction. Specifically, the terms relating to spatial orientation should be understood as they would be understood when the presently described components are mounted to the vehicle, according to at least some embodiments.

Embodiments of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of embodiments of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a top, rear, left side perspective view of a battery pack according to a non-limiting embodiment of the present technology and a portion of a frame member of an electric vehicle;

FIG. 2 is left side elevation view of the battery pack and the frame member portion of FIG. 1;

FIG. 3 is a cross-sectional view of the battery pack and the frame member portion of FIG. 1, taken along line 3-3 of FIG. 2;

FIG. 4 is a top, rear, left side perspective view of the battery pack and the frame member portion of FIG. 1, with a left side cover of the battery pack removed;

FIG. 5 is a top, rear, left side perspective view of a battery pack according to another non-limiting embodiment of the present technology and a portion of a frame member of an electric vehicle, with a left side cover of the battery pack removed;

FIG. 6 is a top, rear, left side perspective view of a battery pack according to yet another non-limiting embodiment of the present technology and portions of two frame members of an electric vehicle;

FIG. 7 is left side elevation view of the battery pack and the frame member portions of FIG. 6;

FIG. 8 is a cross-sectional view of the battery pack and the frame member portions of FIG. 6, taken along line 8-8 of FIG. 7;

FIG. 9 is a top, rear, left side perspective view of a battery pack according to yet another non-limiting embodiment of the present technology and a portion of a frame member of an electric vehicle;

FIG. 10 is a rear, right side perspective view of a frame of an electric all-terrain vehicle (ATV) and a battery pack according to yet another non-limiting embodiment of the present technology;

FIG. 11 is a right side elevation view of an electric snowmobile; and

FIG. 12 is a front, left side perspective view of a portion of a frame of the electric snowmobile of FIG. 11 showing a battery pack according to yet another non-limiting embodiment of the present technology.

It should be noted that, unless otherwise explicitly specified herein, the drawings are not necessarily to scale.

### DETAILED DESCRIPTION

The present technology will be described herein with respect to a battery pack 200 for powering an electric vehicle, as well as alternative embodiments of battery packs 250, 400, 500. Alternative embodiments of battery packs 600, 700 arranged and configured for installation in an electric all-terrain vehicle (ATV) 70 and an electric snowmobile 300, respectively, are also described. The battery packs 200, 250, 400, 500 could be implemented in a variety of other vehicle types, in addition to electric snowmobile and electric ATVs, including but not limited to two-wheeled straddle-seat electric vehicles (e.g. electric motorcycles, electric scooters), three-wheeled electric vehicles (including three-wheeled straddle-seat vehicles), electric side-by-side vehicles (SSVs), and four-wheeled electric vehicles.

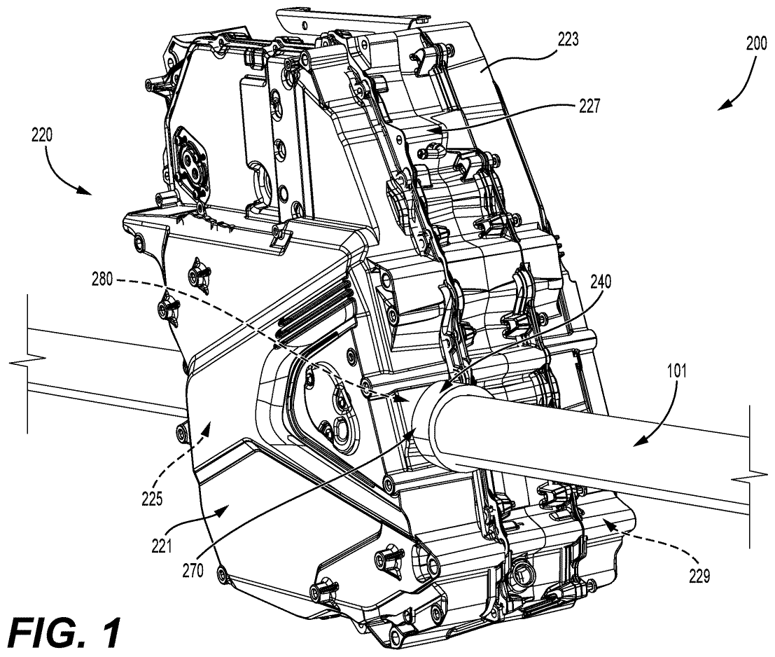

With reference to FIGS. 1 to 4, the battery pack 200 includes a battery housing 220. The battery housing 220 encloses different components of the battery pack 200 and provides connections for connecting to other vehicle components (not shown). In the illustrated embodiment of the battery pack 200, the battery housing 220 (and the corresponding layout of components disposed therein) is shaped for use in a straddle-seat vehicle. In different embodiments of the present technology, it is contemplated that the battery housing 220 could be differently shaped. In some non-limiting examples, the battery housing 220 could be shaped for use in a vehicle having side-by-side seating or in four-wheeled electric vehicles having a passenger cabin.

In the illustrated embodiments, the battery housing 220 has a generally cuboid or parallelepiped form, with three orthogonal axes generally defining the form. The battery housing 220 thus has a first dimension 201 (extending generally vertically in the present orientation), a second dimension 202 (extending generally front-rear in the present orientation), and a third dimension 203 (extending generally left-right in the present orientation), orthogonal to the dimension 201, 202. In the present embodiment, the first dimension 201 is greater than the second dimension 202 and the third dimension 203. It is contemplated that the battery housing 220 could be differently shaped.

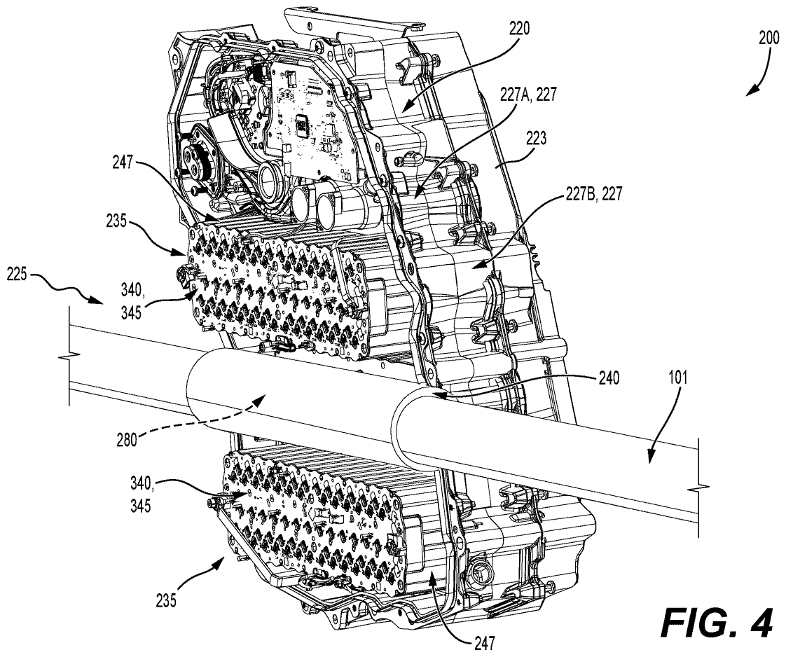

The battery housing 220 includes a housing body 227, forming a center portion of the housing 220. As is illustrated in FIG. 4, the housing body 227 includes a left lateral portion 227A and a right lateral portion 227B connected together to form the body 227. In the illustrated embodiment the left and right lateral portions 227A, 227B are selectively connected together via threaded fasteners (not shown). It is contemplated that the left and right lateral portions 227A, 227B could be otherwise connected together in different manners. In the present embodiment, the housing body 227 is formed from aluminum, but could be formed from different materials, including but not limited to plastic or other metals.

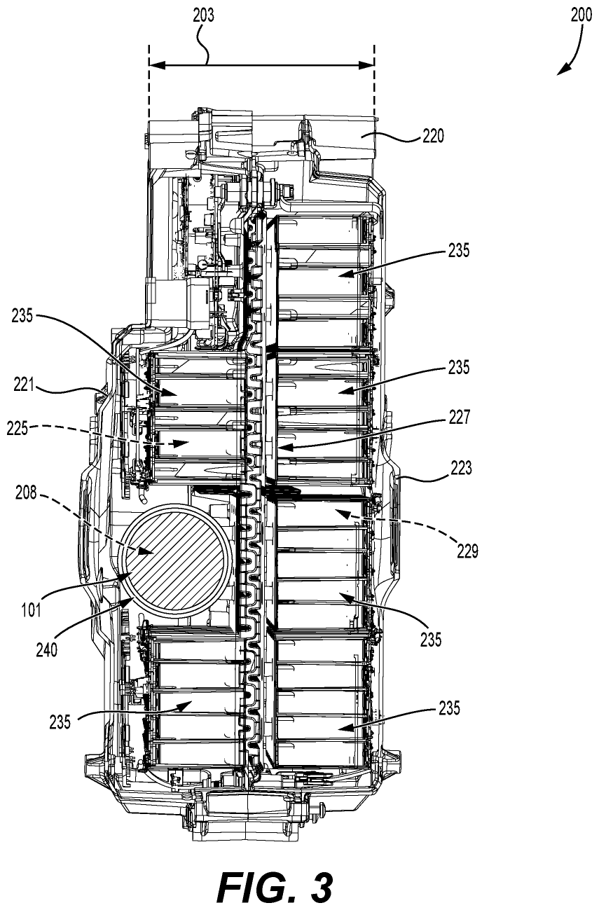

The battery housing 220 includes a left side cover 221 selectively connected to the housing body 227, specifically selectively connected to the left lateral portion 227A. The housing 220 similarly includes a right side cover 223 selectively connected to the housing body 227, specifically selectively connected to the right lateral portion 227B. Each cover 221, 223 is selectively fastened to the housing body 227 to encase the components therein. It is contemplated that the covers 221, 223 could be selectively connected to the housing body 227 in different manners, including for example by tabs. A left chamber 225 is formed between the center portion of the housing body 227 and the left cover 221. A right chamber 229 is formed between the center portion of the housing body 227 and the right cover 223. The left and right chambers 225, 229 are visible in the cross-sectional view of FIG. 3.

The battery pack 200 includes a plurality of battery cells 230 disposed in the battery housing 220. In the present embodiment, the battery cells 230 are cylindrical battery cells 230. More specifically, in the present embodiment, the battery cells 230 are 3.5V cylindrical cells, such as LG™ M50L lithium ion cells in 21700 format, but it is contemplated that different versions of cells could be used in some embodiments. For example, battery cells could vary in nominal energy capacity, usable energy capacity, discharge rate, cell chemistry, cell geometry and cell type.

The battery cells 230 are arranged in a plurality of battery modules 235 disposed in the battery housing 220. In the illustrated embodiment, the battery pack 200 includes six modules 235 of seventy battery cells 230. It is contemplated that each battery module 235 could include more or fewer battery cells 230 or have more or fewer battery modules 235 generally. Depending on the number of battery cells 230 in each module 235 and/or the total number of modules 235 in a given embodiment, it is also contemplated that the total number of battery cells 230 in the battery pack 200 could vary.

The battery modules 235 are separated into two groups of modules: two modules 235 disposed in the left chamber 225 of the housing 220 and four modules 235 disposed in the right chamber 229. Depending on the embodiment, the left and right chambers 225, 229 could contain more or fewer modules 235. It is also contemplated that the left and right chambers 225, 229 could have equal numbers of modules 235.

Each module 235 includes a support matrix 247 for supporting the battery cells 230 (see FIG. 4). The support matrix 247 is formed from a rigid, electrically isolating material, specifically a rigid plastic in the present embodiment. The matrix 247 defines therein seventy generally cylindrical cavities 249 for receiving the battery cells 230 in the support matrix 247. In the illustrated embodiment, the support matrix 247 is formed such that the seventy battery cells 230 of each module 235 are arranged in five parallel rows of fourteen cells 230. It is contemplated that the particular physical distribution in each module 235 could vary. In embodiments where different size formats of cylindrical cells are used, it is contemplated that the matrix 247 could be sized and shaped to receive the different battery format therein.

Each module 235 includes a module board 340 electrically connected to the battery cells 230. The module board 340 includes an integrated current collector 345 disposed within the battery module 235. The integrated current collector 345 electrically couples the battery cells 230 together for collecting energy therefrom. The module board 340 is fastened to the support matrix 247, although the module board 340 could be differently supported in the module 235 depending on the embodiment.

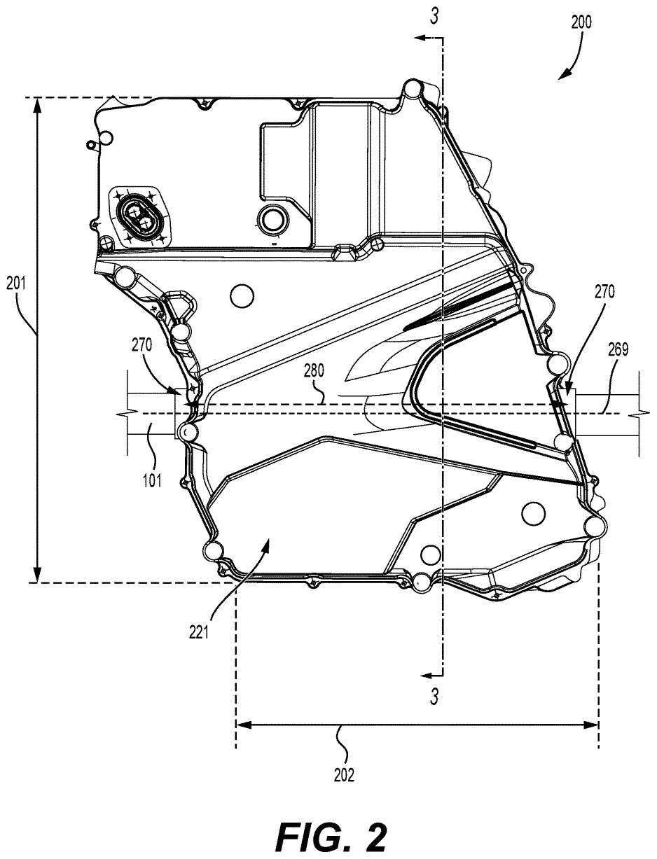

Returning to FIGS. 1 and 2, the battery housing 220, according to non-limiting embodiments of the present technology, is arranged to permit a solid and/or rigid vehicle component to pass through the battery pack 200, thereby providing flexibility in the placement of the battery pack 200 within the electrical vehicle infrastructure. It is noted that a “solid” vehicle component refers simply to non-fluid vehicle components, such as coolant flowing through a passage through the battery housing 220 for example. It is further noted that a “rigid” vehicle component refers simply to vehicle components not generally configured to bend or majorly deform under standard usage.

A passage 280, described further below, and other embodiments thereof, are sized and arranged to permit placement of the corresponding battery pack that may overlap with a rigid operative or structural component of the electric vehicle. As will be described in more detail below, such components could include but are not limited to: frame members, steering columns, and drive shafts. It is noted that the passage 280 is not necessarily contemplated to the sealed in order to permit the flow of liquids therethrough; by the present technology, the passage 280 is sized and arranged to permit extension of operative or communicative components to extend therethrough from one side of the battery pack 200 to the other side of the battery pack 200.

Specifically, the battery housing 220 of the battery pack 200 defines therein two apertures, a rear aperture 270 and a front aperture 272, and a passage 280 for receiving the rigid vehicle component extending through the battery pack 200. As is illustrated for the various embodiments of a passage described herein, at least a portion of the passage is enclosed by an exterior surface of the housing 220. The passage 280, and other illustrated embodiments thereof, thus extend at least partially through an interior of the battery pack 200, such that the vehicle component extending therethrough is enclosed by the housing 220.

The apertures 270, 272 are both defined by the left side cover 221. In some embodiments, it is contemplated that the apertures 270, 272 could be defined by the right side cover 223. It is also contemplated that one of the apertures 270, 272 could be defined in each of the left and right side covers 221, 223. As will be illustrated in further embodiments, apertures could be defined in part by one of the side covers 221, 223 and in part by the central housing body 227. In such a case the two apertures would generally be considered left and right side apertures, although it is noted that the battery pack 200 could be installed in the electric vehicle in a variety of the orientations and the orientations assigned herein are simply for ease of reference.

The passage 280 extends through the battery pack 200 from the rear aperture 270 to the front aperture 272. The passage 280 defines an open path through the battery pack 200, along which a vehicle component could be extend through the battery pack 200 without contacting internal components of the battery pack 200.

In the Figures, a portion of a frame member 101 is illustrated extending through the apertures 270, 272 and the passage 280, as one non-limiting example of use of the battery housing arrangement to accommodate the battery pack 200 into an electric vehicle structure. The apertures 270, 272 and the passage 280 of the illustrated embodiment are sized and arranged for receiving the frame member 101 of a frame (not shown) of the electric vehicle through the battery pack 200, when the battery pack 200 is installed in the electric vehicle. As is described in more detail below, the frame member 101 is simply one non-limiting embodiment of a vehicle component to be accommodated by the passage 280. By the present technology, the battery pack 200 can be adapted to received rotating rigid components therein, such as steering columns and drive shafts.

In the illustrated embodiment, the passage 280 extends linearly between the apertures 270, 272. Specifically, the apertures 270, 272 are aligned such that a line 269 extending normal to and through a center of the rear aperture 270 extends normal to and through a center of the front aperture 272 (illustrated in FIG. 2). In at least some embodiments, it is contemplated that the passage 280 could be curved or could deviate from a straight path in order to receive therethrough a component, for example, that has a bend or curvilinear shape. The passage 280 also extends generally parallel to the second dimension 202 of the battery pack 200 in the present embodiment. As will be further described below, passages through different embodiments of the battery pack 200 could be differently oriented within the battery housing 220. It is also contemplated that the passage 280 could be arranged at an angle skewed to the major axes of the housing body 220.

The battery pack 200 further includes, in the embodiment of FIGS. 1 to 3, a conduit 240 forming at least a portion of the passage 280. The conduit 240 extends from the rear aperture 270 to the front aperture 272. The conduit 240 extends out through the apertures 270, 272 in the present embodiment, but it is contemplated that the conduit 240 could be sized to extend only between the apertures 270, 272 or to cover only a portion of the distance between the apertures 270, 272. In at least some embodiments, the conduit 240 could be integrally formed with the housing 220, such that the outer surfaces of the housing 220 are smoothly connected to internal surfaces of the conduit 240. The conduit 240 is sized and arranged to receive the frame member 101 therethrough. As can be seen in FIG. 4, the conduit 240 is disposed between two battery modules 235 in the left chamber 225.

The conduit 240 provides a physical barrier between the frame member 101 (or another vehicle component passed therethrough along the passage 280) and the internal components of the battery pack 200. As can be seen in FIG. 3, the passage 280 is sized and arranged to provide space for the frame member 101 to extend therethrough, and additional permit an air gap between the frame member 101 and the sides of the conduit 240. In at least some embodiments, the conduit 240 could also provide vibrational and/or electrical insulation between the vehicle component and the internal components of the battery pack 200. As such, in at least some embodiments, the battery pack 200 would maintain an ingress protection rating (IP rating), including water-resistance requirements, even with the presence of the passage 280 through the housing 220.

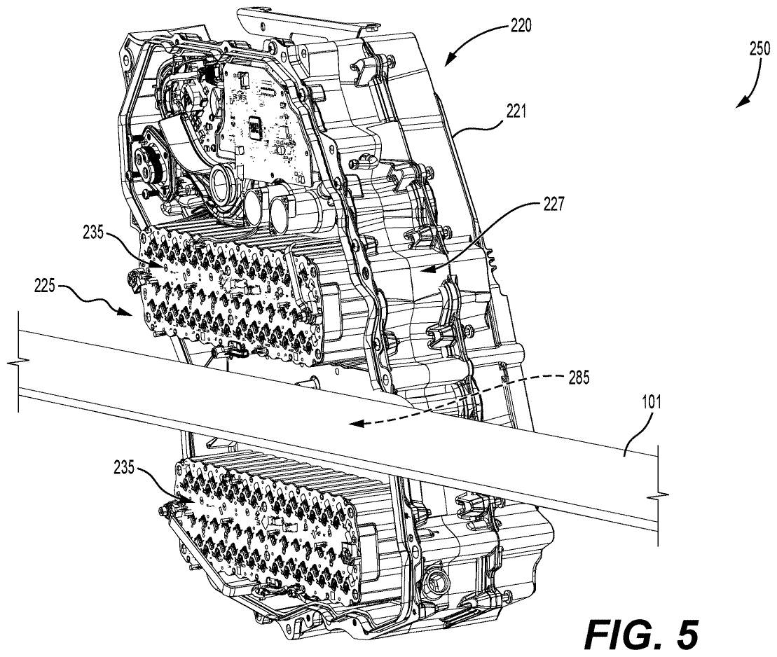

Another embodiment of a battery pack 250 according to the present technology is illustrated in FIG. 5. Elements of the battery pack 250 that are similar to those of the battery pack 200 retain the same reference numeral and will generally not be described again.

The battery pack 250 is similar to the battery pack 200, with the conduit 240 having been omitted. As such, a passage 285 defined through the battery housing 220 is defined by different components and structures of the battery pack 250. The passage 285 is defined in part by a portion of the battery cells 230. The passage 285 is defined between a bottom side of one battery module 235 and a top side of a lower battery module 235 of the left side chamber, as well as by a surface of the housing body 227. While it is not shown explicitly, the passage 285 is further defined by the left side cover 221 and the apertures 270, 272. In different embodiments, it is contemplated that more or less of the passage 285 could be defined battery cells 230. For instance, the passage 285 could be defined between a bottom portion of the housing 220 and below the battery cells 230 disposed in the housing 220, or between an upper portion of the housing 220 and above the battery cells 230 disposed in the housing 220.

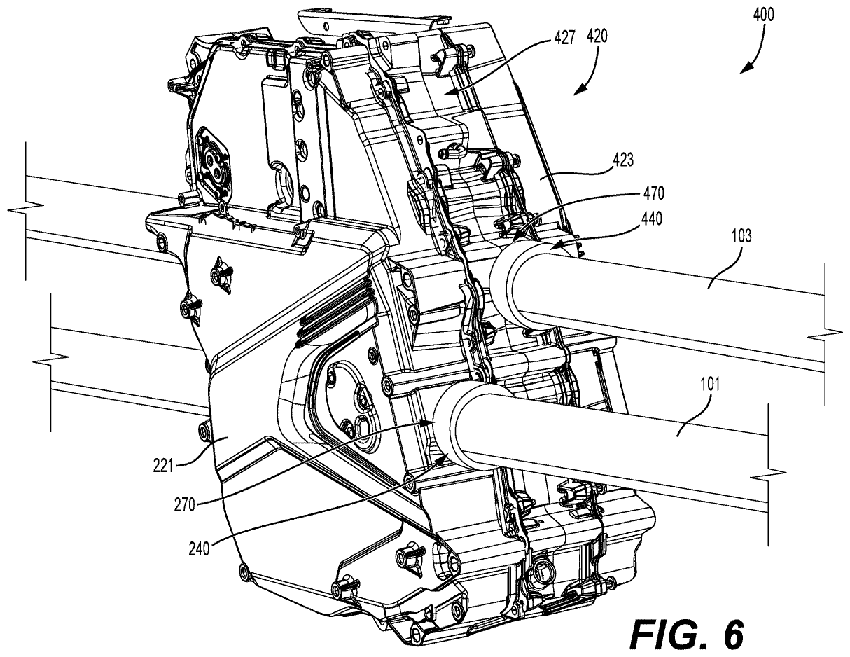

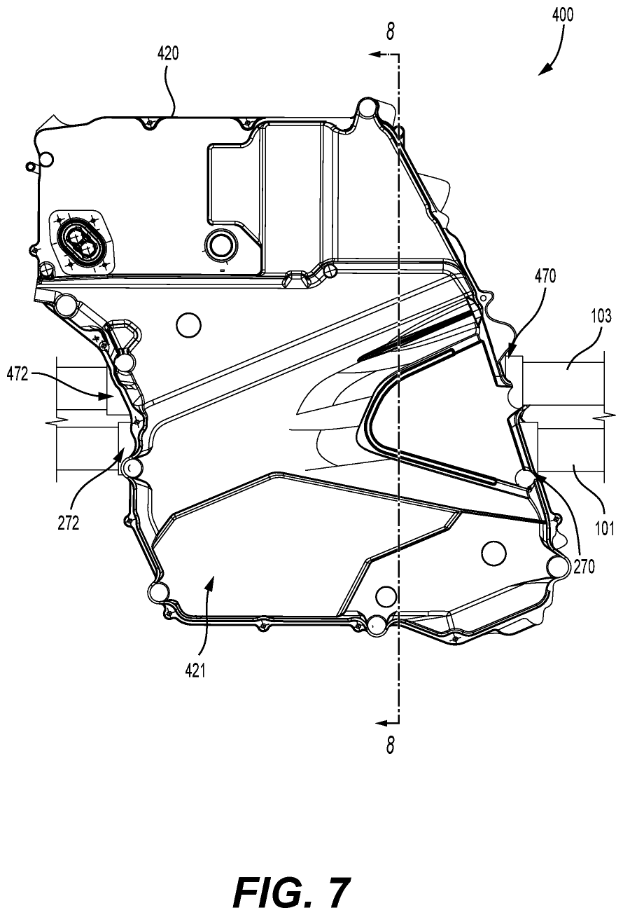

Yet another embodiment of a battery pack 400 according to the present technology is illustrated in FIGS. 6 to 8. Elements of the battery pack 400 that are similar to those of the battery pack 200 retain the same reference numeral and will generally not be described again.

In addition to the conduit 240 and the passage 280, the battery pack 400 is further arranged for receiving therethrough a second vehicle component. In the illustrated non-limiting example, a portion of a second frame member 103 is shown passing through the battery pack 400, although it is noted that a variety of vehicle components could be arranged in conjunction with the battery pack 400.

The battery pack 400 has the first passage 280, as described above with respect to the battery pack 200. The battery pack 400 further includes a second passage 480 defined through a battery housing 420. The battery pack 400 further includes a second conduit 440 disposed in the right side chamber 229 and extending through the housing 420.

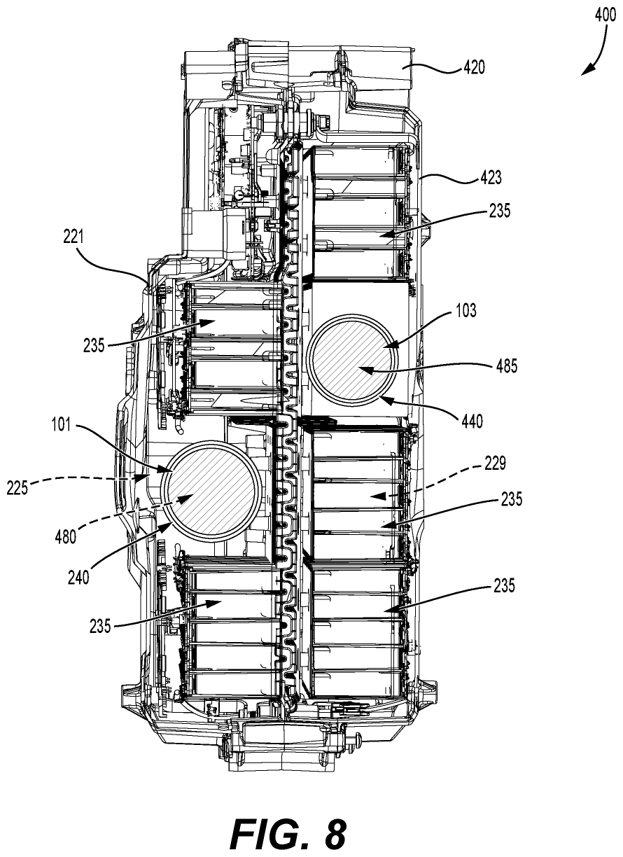

The housing 420 defines therein a rear aperture 470 and a front aperture 472, the passage 480 then being defined by at least the apertures 470, 472 and the conduit 440. The apertures 470, 472 are defined in part by the right side cover 423 and the housing body 427, as is illustrated by in FIG. 6 for the rear aperture 470. In some cases, the apertures 470, 472 could be defined by only the right side cover 423. It is also contemplated that the second passage 480 could be defined on a same side as the first passage 280, for example with the apertures 470, 472 being defined by the left side cover 221. As can be seen in FIG. 8, the right chamber 229 encloses three battery modules 235, with the passage 480 extending between two battery modules 235 and through a space occupied by an additional battery module 235 in the battery pack 200. It is noted that depending on the number and arrangement of passages through any given embodiment of the battery pack 200, 400, the number and type of battery cell 230 could be differently chosen in order to both accommodate the volume occupied by passage(s) through the battery housing and the total energy needed to be produced by the battery pack 200, 400.

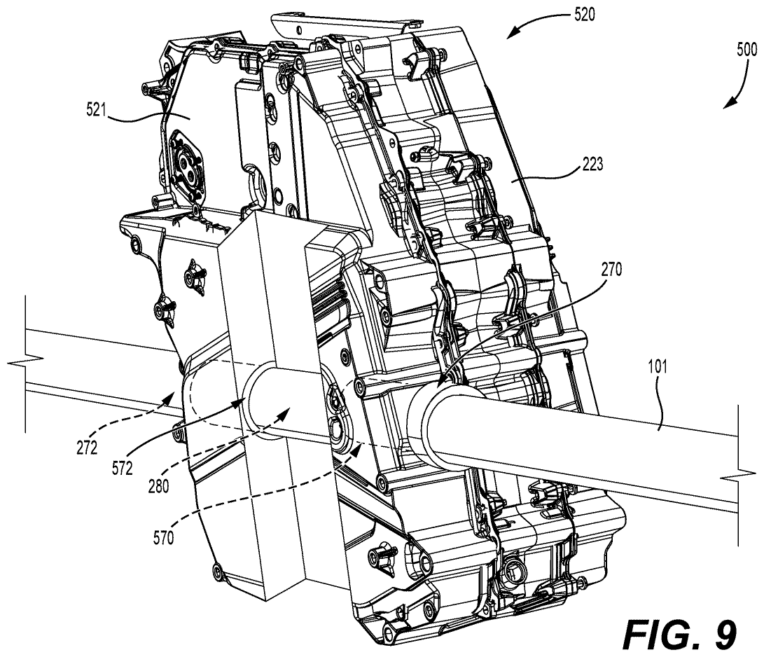

Yet another embodiment of a battery pack 500 according to the present technology is illustrated in FIG. 9. Elements of the battery pack 500 that are similar to those of the battery pack 200 retain the same reference numeral and will generally not be described again.

The battery pack 500 includes a left side cover 521 selectively connected to the housing body 227. The left side cover 521 is shaped such that the frame member 101 extends through four apertures when disposed in the passage 280. Specifically, the passage 280 is partially defined by the rear aperture 270, a first intermediate aperture 570, a second intermediate aperture 572, and the front aperture 272. Depending on the particular form of the housing 520, it is contemplated that more or less of the passage 280 could defined in an interior of the housing 520. It is also contemplated that the intermediate apertures 570, 572 could have different shapes, including for instance exposing only a portion of the passage 280.

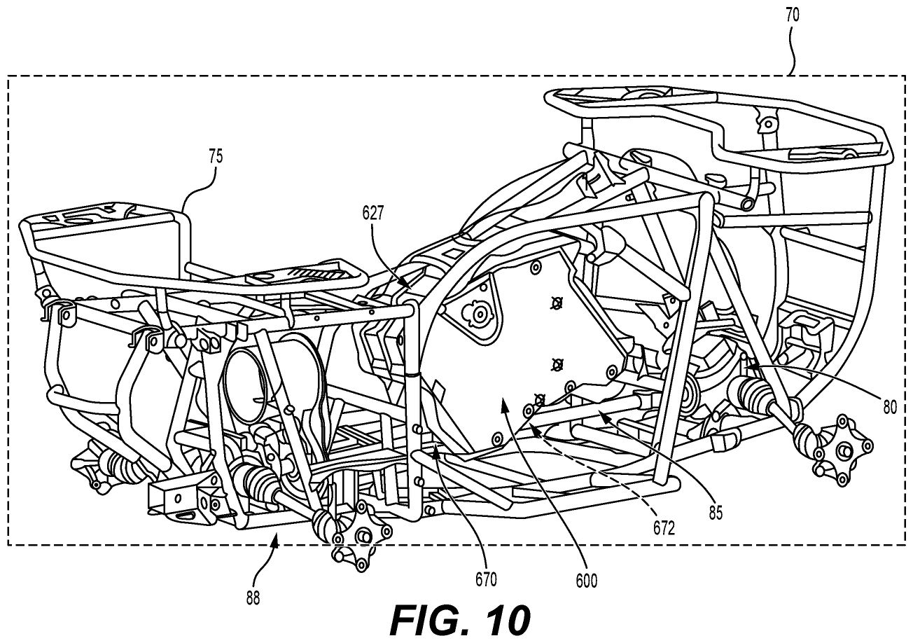

Yet another embodiment of a battery pack 600 according to the present technology is illustrated in FIG. 10. Elements of the battery pack 600 that are similar to those of the battery pack 200 retain the same reference numeral and will generally not be described again.

The battery pack 600 is arranged and configured to be installed in an electric all terrain vehicle (ATV) 70, shown partially schematically. A frame 75 of the ATV 70 is illustrated, with the battery pack 600 installed therein. A motor 80 of the ATV 70 is operatively connected to a rear drive assembly 88 by a drive shaft 85. Due to the relative size of the battery pack 600 versus the space available within the frame 75, the drive shaft 85 extends through at least a portion of the volume required to install the battery pack 600 inside the frame 75.

As such, the battery pack 600, and more specifically apertures 670, 672, and a passage 680 thereof, are sized and arranged to receive the drive shaft 85 through the battery pack 600 as installed in the electric vehicle 70. The battery pack 600 includes a conduit (not shown) forming a protective barrier between the rotating and vibrating drive shaft 85 and the internal components of the battery pack 600, although different protective arrangements are contemplated.

As was noted previously, the battery pack 600 and other embodiments described herein may be installed in various orientations in the corresponding electric vehicle. As is illustrated in FIG. 10, the passage 680 extends through a battery housing 620 of the battery pack 600 in a longitudinal direction, such that the passage 680 is arranged generally parallel to the longest dimension of the battery housing 620. The apertures 670, 672 are defined in part by a housing body 627 of the housing 620, such that the passage 680 extending therebetween is disposed between the battery cells 230 (not specifically shown) disposed in the chambers 225, 229.

It is contemplated that the battery pack 600 could be sized and arranged to receive therein other solid or rigid components of the ATV 70. These could include but are not limited to: portions of the frame 75 and steering assembly components.

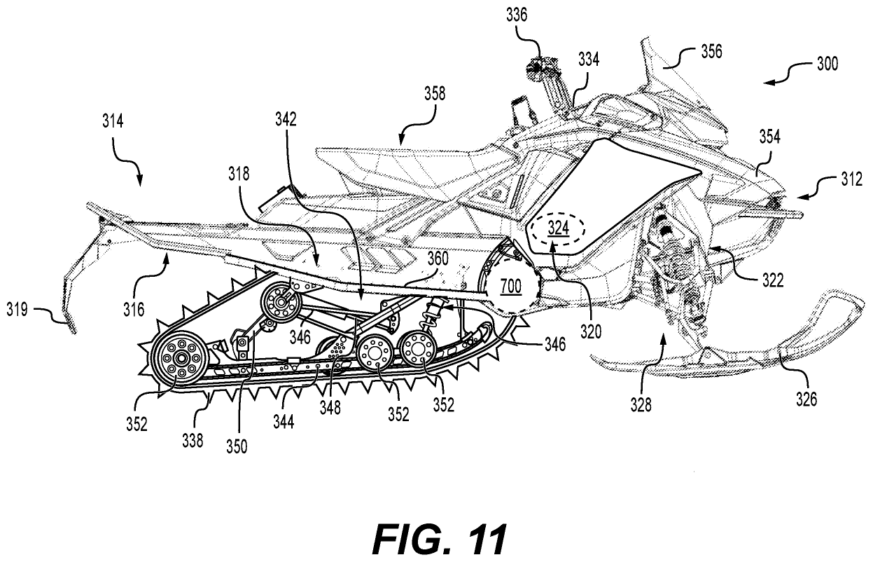

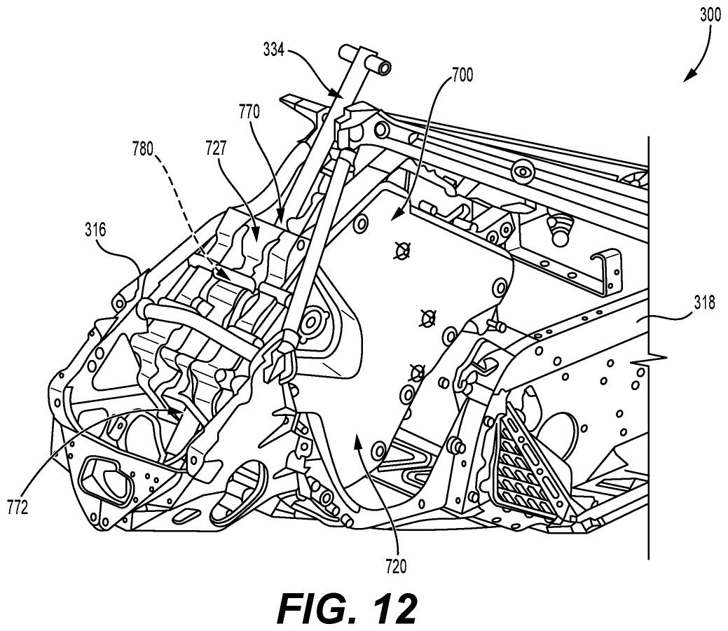

With reference to FIGS. 11 and 12, a non-limiting embodiment of an electric vehicle utilizes a battery pack 700, similar to the battery pack 200 and described further below. Elements of the battery pack 700 that are similar to those of the battery pack 200 retain the same reference numeral and will generally not be described again.

Specifically, an electric snowmobile 300 is described and illustrated in FIG. 11. The snowmobile 300 includes a forward end 312 and a rearward end 314 that are defined consistently with a forward travel direction of the snowmobile 300. The snowmobile 300 includes a frame 316 that includes a tunnel 318, a motor cradle portion 320 and a front suspension assembly portion 322.

The snowmobile 300 includes the battery pack 700 and an electric motor 324 (shown schematically), carried by the motor cradle portion 320 of the frame 316. Two skis 326 (a right ski 326 being illustrated) are positioned at the forward end 312 of the snowmobile 300 and are attached to the front suspension assembly portion 322 of the frame 316 through front suspension assemblies 328. A steering device in the form of handlebar 336 is attached to the upper end of the steering column 334 to allow a driver to rotate the skis 326, in order to steer the snowmobile 300.

An endless drive track 338 is disposed generally under the tunnel 318 and is operatively connected to the motor 324. The endless drive track 338 is driven to run about a rear suspension assembly 342 for propulsion of the snowmobile 300. The rear suspension assembly 342 includes a pair of slide rails 344 in sliding contact with the endless drive track 338. The rear suspension assembly 342 also includes a plurality of shock absorbers 346. Suspension arms 348 and 350 are provided to attach the slide rails 344 to the frame 316. A plurality of idler wheels 352 are also provided in the rear suspension assembly 342. Other types and geometries of rear suspension assemblies are also contemplated.

At the forward end 312 of the snowmobile 300, fairings 354 enclose internal components of the snowmobile 300. A windshield 356 is connected to the fairings 354 near the forward end 312 of the snowmobile 300. Alternatively, the windshield 356 could be connected directly to the handlebar 336. The windshield 356 acts as a wind screen to lessen the force of the air on the driver while the snowmobile 300 is moving forward.

A straddle seat 358 is positioned over the tunnel 318. Two footrests 360 are positioned on opposite sides of the snowmobile 300 below the seat 358 to accommodate the driver's feet. A snow flap 319 is disposed at the rear end 314 of the snowmobile 300. The tunnel 318 consists of one or more pieces of sheet metal arranged to form an inverted U-shape that is connected at the front to the motor cradle portion 320 and extends rearward therefrom.

The snowmobile 300 has other features and components which would be readily recognized by one of ordinary skill in the art, further explanation and description of these components will not be provided herein.

With reference to FIG. 12, the battery pack 700 is disposed in a forward portion of the frame 316. The battery pack 700, and more specifically two apertures 770, 772 and a passage 780, are sized and arranged for receiving the steering column 334 through the battery pack 700 as installed in the electric snowmobile 700.

The passage 780 extends through a battery housing 720 of the battery pack 700 in a generally longitudinal direction, such that the passage 780 is arranged at an angle slightly skewed to the longest dimension of the battery housing 720 and parallel to a front side of the battery housing 720. The apertures 770, 772 are defined in part by a housing body 727 of the housing 720, such that the passage 780 extending therebetween is disposed between the battery cells 230 (not specifically shown) disposed in the chambers 225, 229.

It is contemplated that the battery pack 700 could be sized and arranged to receive therein other solid or rigid components of the snowmobile 300. These could include but are not limited to: portions of the frame 316 and drive assembly components extending through the battery pack 700.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

What is claimed is:

1. A battery pack for an electric vehicle, the battery pack comprising:
a battery housing; and
a plurality of battery cells disposed in the battery housing,
the battery housing defining therein:
a first aperture, and
a second aperture,
a passage through the battery pack extending from the first aperture to the second aperture,
the at least one passage being arranged to receive at least one solid vehicle component extending through the battery pack.

2. The battery pack of claim 1, wherein the passage extends linearly between the first aperture and the second aperture.

3. The battery pack of claim 1, wherein the first aperture is aligned with the second aperture, such that a line extending normal to a center of the first aperture extends normal to and through a center of the second aperture.

4. The battery pack of claim 1, further comprising a conduit extending at least partially from the first aperture to the second aperture, the passage being formed at least in part through the conduit.

5. The battery pack of claim 1, wherein the passage is defined at least in part by a portion of the plurality of battery cells.

6. The battery pack of claim 1, wherein:
the battery housing includes:
a housing body,
a first cover selectively connected to the housing body, a first chamber being defined between the housing body and the first cover, and
a second cover selectively connected to the housing body on a side of the housing body opposite the first cover, a second chamber being defined between the housing body and the second cover;
a first subgroup of battery cells of the plurality of battery cells is disposed in the first chamber; and
a second subgroup of battery cells of the plurality of battery cells is disposed in the second chamber.

7. The battery pack of claim 6, wherein the first aperture and the second aperture are both defined by one of the first cover and the second cover.

8. The battery pack of claim 6, wherein the first aperture and the second aperture are defined at least in part by the housing body.

9. The battery pack of claim 1, wherein:
the passage is a first passage; and
a second passage is defined through the battery housing.

10. The battery pack of claim 1, wherein:
the battery housing defines therein:
a third aperture, and
a fourth aperture; and
the passage through the battery pack is defined at least in part by the first aperture, the second aperture, the third aperture, and the fourth aperture.

11. The battery pack of claim 1, wherein:
the battery housing has a first dimension and a second dimension orthogonal to the first dimension; and
the first dimension is greater than the second dimension.

12. The battery pack of claim 11, wherein the passage extends generally parallel to the first dimension of the battery pack.

13. The battery pack of claim 11, wherein the passage extends generally parallel to the second dimension of the battery pack.

14. The battery pack of claim 1, wherein the first aperture, the second aperture, and the passage are sized and arranged for receiving a drive shaft of the electric vehicle through the battery pack, when the battery pack is installed in the electric vehicle.

15. The battery pack of claim 1, wherein the first aperture, the second aperture, and the passage are sized and arranged for receiving a steering column of the electric vehicle through the battery pack, when the battery pack is installed in the electric vehicle.

16. The battery pack of claim 1, wherein the first aperture, the second aperture, and the passage are sized and arranged for receiving a frame member of a frame of the electric vehicle through the battery pack, when the battery pack is installed in the electric vehicle.

17. The battery pack of claim 1, wherein:
the at least one solid vehicle component is a rigid vehicle component; and
the at least one passage is arranged to receive the rigid vehicle component through the battery pack.

18. The battery pack of claim 17, wherein the rigid vehicle component is a rotating rigid vehicle component.

19. An electric vehicle comprising:
a frame;
a straddle seat supported by the frame;
at least one ground-engaging member operatively connected to the frame;
an electric motor being operatively connected to the at least one ground-engaging member for driving the at least one ground-engaging member;
an electric powerpack operatively connected to the electric motor, the powerpack comprising:
a battery pack comprising:
a battery housing; and
a plurality of battery cells disposed in the battery housing,
the battery housing defining therein:
a first aperture, and
a second aperture,
a passage through the battery pack extending from the first aperture to the second aperture,
the at least one passage being arranged to receive at least one solid vehicle component extending through the battery pack.

20. The electric vehicle of claim 19, further comprising:
a steering column operatively connected to the at least one ground-engaging member,
the steering column extending through the passage of the battery pack.

21. The electric vehicle of claim 19, wherein:
the at least one ground engaging member includes two skis; and
the vehicle is a snowmobile.

22. The electric vehicle of claim 19, wherein:
the at least one solid vehicle component is a rigid vehicle component; and
the at least one passage is arranged to receive the rigid vehicle component through the battery pack.

23. The electric vehicle of claim 22, wherein the rigid vehicle component is a rotating rigid vehicle component.
